(19) United States
(12) Patent Application Publication
(10) Pub. No.: US 2024/0304860 A1
(43) Pub. Date: Sep. 12, 2024

(54) NON-GAS-EVOLVING IN-SITU CURED QUASI SOLID-STATE BATTERIES

(71) Applicant: Nano and Advanced Materials Institute Limited, Hong Kong (HK)

(72) Inventors: Soon Yee LIEW, Hong Kong (HK); Ho Mei LAW, Hong Kong (HK); Fei ZHANG, Hong Kong (HK); Yu Tat TSE, Hong Kong (HK); Shengbo LU, Hong Kong (HK); Li FU, Hong Kong (HK); Yong ZHU, Hong Kong (HK); Chenmin LIU, Hong Kong (HK); Yan Lung WONG, Hong Kong (HK)

(21) Appl. No.: 18/595,466

(22) Filed: Mar. 5, 2024

Related U.S. Application Data
(60) Provisional application No. 63/489,187, filed on Mar. 9, 2023.

(51) Int. Cl. H01M 10/0565; H01M 4/66

(52) U.S. Cl. CPC H01M 10/0565; H01M 4/661; H01M 2300/0082

(57) ABSTRACT

A quasi-solid-state battery formed from non-gas evolving in-situ curing of a quasi-solid-state electrolyte that includes a high swelling polymer made from a monomer with good compatibility with liquid electrolytes, and has a good reactivity for facile non-gas evolving in-situ polymerization. The monomer can be based on acrylate polymerization chemistry or an allyl group polymerization chemistry. Non-gas evolving initiators are used for non-gas evolving in-situ polymerization of acrylate or allyl monomer-based QSE. The resulting QSE additionally has high ionic conductivity, allowing for a high battery output, and a wide electrochemical window (stable for lithium metal anode and high-voltage cathodes). The resulting quasi solid electrolyte battery is not only easy to fabricate using conventional battery manufacturing practices, the non-gas evolving in-situ polymerization causes the QSE to be uniformly distributed within the battery, ensuring high-quality, safe battery performance and longevity.

### CROSS-REFERENCE TO RELATED APPLICATION

The present application claims priority from a U.S. provisional application Ser. No. 63/489,187 filed 9th March 2023, and the disclosures of which are incorporated by reference in their entirety.

### FIELD OF THE INVENTION

The present invention relates to a quasi-solid-state battery formed from non-gas-evolving in-situ curing of a quasi-solid-state electrolyte (QSE).

### BACKGROUND

The development of batteries of higher energy density is a current trend. Achieving higher energy density batteries can improve applications/devices that depend on an energy supply from a limited number of batteries packed into a tight area as well as possibly empowering new applications. Increasing battery energy density results in the same space containing a higher amount of energy and can provide suitable power for consumer electronics and electric vehicles. However, in the event of catastrophic failure such as short circuit or thermal runaway, higher energy density batteries release a greater amount of thermal energy, typically causing fire or explosion. It is foreseeable that higher energy density batteries will result in higher intensity burning or explosion. Therefore, there is a need for safer electrolytes that prevent fires/explosions while simultaneously providing the high electrochemical performance needs of these batteries.

The paramount example of a high energy-density battery is a lithium metal battery. Using lithium metal as the battery anode, the highest battery energy density can be achieved since lithium has the highest specific capacity of any metal, and also the most negative reduction potential of any known metal species. Successful commercialization of lithium metal batteries however depends on whether (1) dendrite formation can be adequately suppressed and (2) safety issues can be fully addressed. Solid electrolytes, such as ceramic electrolytes or polymer electrolytes have been suggested as a potential solution to these problems. As these types of electrolytes are non-volatile, their application in batteries improves safety regarding fire hazards. Furthermore, solid electrolytes such as ceramics also have high strength, and it is thought that lithium dendrites will not penetrate the ceramic electrolytes, thereby alleviating the risk of short circuits. However, solid electrolytes such as polymers or ceramics still suffer from poor chemical stability against lithium metal and/or cathode materials resulting in a poor solid-to-solid interfacial contact with both the cathode and anode. Consequently, achieving a functional battery is a challenging problem for solid electrolytes.

A more reasonable approach to solid electrolytes is a solid-liquid composite electrolyte, more widely known as a quasi-solid electrolyte (QSE). In quasi-solid electrolytes, an ion conductive electrolytic solution is included with a solid electrolyte component. Having a liquid component overcomes the poor interfacial compatibility of solid electrolytes; as a result, QSEs can exhibit comparable electrochemical performance to liquid electrolytes. A typical QSE includes a gel polymer network, including a polymer or polymer system and a liquid electrolyte, gelling together to form the QSE composite. Understandably, the use of QSEs provides the batteries with higher safety due to the gel structure confinement of the volatile liquid electrolytes, therefore making it less likely to ignite than pure liquid electrolyte. The QSE is introduced into the dry cell of the battery as a precursor solution, using the liquid electrolyte to carry monomeric components of a polymer into the battery. The curing of the polymer in-situ within the battery after a suitable wetting duration ensures a good electrolytic contact with the electrodes. The method by which the QSE is introduced into batteries is highly compatible with current battery manufacturing practices, making QSEs highly attractive for battery manufacturers.

However, QSE batteries can easily suffer from poor performance if gas is generated during the curing process. Gas species generated in QSEs have no easy escape route and can cause serious problems when the gas species nucleate to form gas bubbles. Gas bubbles in the QSE not only disrupt the uniformity of the electrolyte layer, but also create voids into which lithium dendrites preferentially grows. Thus, there is a need in the art for improved quasi solid-state electrolytes for lithium or lithium ion batteries.

### SUMMARY OF THE INVENTION

In the present invention, the disadvantage of prior art QSEs that generate gas bubbles is overcome by employing an innovative non-gas evolving in-situ curing method. The resultant quasi solid-state batteries have a uniform QSE structure, which is necessary for good battery performance. Additionally, the non-gas-evolving QSE accommodates a wide range of liquid electrolytes, making it suitable for a wide variety of batteries useful for many commercial applications. Examples using a lithium metal battery based on lithium metal anode, and a lithium ion battery based on graphite anode, are shown.

In the present invention, the quasi-solid state battery formed from a non-gas evolving in-situ curing of a quasi-solid-state electrolyte includes high swelling monomers with good compatibility with liquid electrolytes, and has a good reactivity for facile non-gas-evolving in-situ polymerization. The monomer can be based on acrylate polymerization chemistry or allyl group polymerization chemistry. Non-gas evolving initiators are used for non-gassing in-situ polymerization of acrylate or allyl monomer-based QSE. The resulting QSE additionally has high ionic conductivity, allowing for a high battery output, and a wide electrochemical window (that is, it is stable for lithium metal use and also stable for high-voltage cathodes). As a result, the quasi solid electrolyte battery is not only easy to fabricate using conventional battery manufacturing practices, the non-gassing in-situ polymerization causes the QSE to be uniformly distributed within the battery, ensuring high-quality, safe battery performance and longevity.

In one aspect, the present invention provides a method for fabricating a non-gas evolving in-situ cured quasi solid-state battery involving synthesizing at least one high ion conductivity electrolytic solution by mixing one or more lithium salts with a solvent. A quasi-solid electrolyte precursor solution is prepared by mixing at least one monomer, the high ion conductivity electrolytic solution, and a non-gas evolving polymerization initiator.

The quasi-solid electrolyte precursor solution is injected into a pre-packaged lithium battery. The battery filled with the quasi-solid electrolyte precursor is subjected to a conditioning step for electrode wetting. This is followed by in-situ curing for curing the quasi-solid electrolyte by heating at a temperature in the range of 50-80° C. for a duration no more than 12 hours.

The non-gas evolving in-situ curable quasi solid electrolyte precursor solution may include a monomer in the range of 3-50% by weight, and an ion conductive electrolytic solution in the range of 50-97% by weight.

The ion conductive electrolytic solution may be a carbonate-based electrolytic solution or a glyme-based electrolytic solution.

In one aspect, the quasi-solid electrolyte precursor solution contains a non-gas evolving polymerization initiator which may be a quaternary ammonium persulfate compound, a quaternary phosphonium persulfate compound or imidazolium persulfate compound.

The monomer may be one or more of an acrylate-based monomers or an allyl-based monomer.

The monomer may have a molecular weight in a range between 250-3000 per unit of a polymerization functional group of a backbone of an in-situ cured polymer.

The monomer may have one or more polymerization functional groups on each monomer, having a number selected from 1, 2, 3, 4, 5 or 6.

The ion conductive electrolytic solution may be a carbonate-based electrolytic solution having a carbonate solvent, one or more lithium salts and one or more additives. The carbonate solvent may be one or more of ethylene carbonate (EC), propylene carbonate (PC), dimethyl carbonate (DMC), diethyl carbonate (DEC), ethyl methyl carbonate (EMC), fluoroethylene carbonate (FEC), vinylene carbonate (VC), or a combination thereof; and the one or more lithium salts are selected from one or more of lithium hexafluorophosphate (LiPF₆), lithium tetrafluoroborate (LiBF₄), lithium bisfluorosulfonylimide (LiFSI), lithium bis(trifluoromethanesulfonyl)imide (LiTFSI), lithium bis(oxalate) borate (LiBOB), lithium difluoro(oxalato) borate (LiDFOB), lithium difluorophosphate (LiDFP), lithium nitrate; and the one or more additives are selected from one or more of tris(trimethylsilyl) phosphate (TMSP), tris(trimethylsilyl) borate (TMSB), tris(trimethylsilyl) phosphite (TMSPi), succinonitrile, adiponitrile.

In another aspect, the ion conductive electrolytic solution is a glyme-based electrolytic solution with a glyme solvent and one or more lithium salts. The glyme solvent is selected from one or more of dimethoxyethane (DME), diethoxyethane (DEE), diethylene glycol dimethyl ether (diglyme, or G2), triethylene glycol dimethyl ether (triglyme, or G3), tetraethylene glycol dimethyl ether (tetraglyme, or G4), diethylene glycol diethyl ether (DEGDEE, or ethyl diglyme). The one or more lithium salts may be one or more of lithium bisfluorosulfonylimide (LiFSI), lithium bis(trifluoromethanesulfonyl)imide (LiTFSI), lithium bis(oxalate) borate (LiBOB), lithium difluoro(oxalato) borate (LiDFOB), lithium difluorophosphate (LiDFP), lithium nitrate.

The non-gas evolving polymerization initiator may be one or more of tricaprylmethylammonium persulfate, tetrabutylphosphonium persulfate, or trihexyltetradecylphosphonium persulfate, or 1-octyl-3-methylimidazolium persulfate.

In another aspect, the present invention provides a non-gas-evolving in-situ cured quasi solid state battery. The battery includes an in-situ cured quasi solid electrolyte having a swellable polymer content of 3% to 10% that is formed using a non-gas evolving polymerization initiator. A liquid amount of 90% to 97% is provides such that the ionic conductivity and transport property approximates a liquid electrolyte.

The battery further includes a separator, the separator having a first side and a second side. A battery positive electrode is positioned adjacent to the first side of the separator; and a battery negative electrode is positioned adjacent to the second side of the separator. The battery positive electrode is a cathode while the negative electrode is an anode.

In one aspect, the battery positive electrode may include an aluminum current collector coated with one or more of lithium cobalt oxide (LCO), lithium manganese oxide (LMO), lithium iron phosphate (LFP), lithium nickel manganese cobalt oxide (NMC and NMC532), nickel rich lithium nickel manganese cobalt oxide (NMC622 or NMC811), lithium nickel cobalt aluminum oxide (NCA), lithium cobalt phosphate (LiCoPO₄) lithium vanadium phosphate (LVP), or a combination thereof.

The battery negative electrode may include a copper current collector coated with one or more of lithium metal, graphite, hard carbon, soft carbon, a silicon-carbon composite, a silicon oxide-carbon composite, a sulfur-carbon composite, lithium titanium oxide, or a combination thereof.

The separator may be a polyethylene (PE) separator, a polypropylene (PP) separator, a polytetrafluoroethylene (PTFE) separator, a polyimide (PI) separator, or a multilayer composite separator such as a PP-PE-PP tri-layer separator.

In another aspect, the present invention provides a quasi-solid electrolyte precursor solution. The solution includes one or more monomer precursors of a swellable polymer in an amount from 3 to 10 weight percent. An ion conductive electrolytic solution is included in an amount from 90 to 97 weight percent along with a non-gas evolving polymerization initiator.

The non-gas evolving polymerization initiator may be a quaternary ammonium persulfate compound or a quaternary phosphonium persulfate compound or an imidazolium persulfate compound.

### BRIEF DESCRIPTION OF THE DRAWINGS

FIGS. 1A to 1C depicts examples of gas-free polymerization initiators. FIG. 1A depicts a quaternary ammonium persulfate; FIG. 1B depicts a tetrabutylphosphonium persulfate (TPP); and FIG. 1C depicts an octyl-methylimidzaolium (C8MIm) persulfate.

FIG. 2 depicts the radical generation of a typical nitrile-based initiator, azobisisobutyronitrile (AIBN), which gives off a molecule of nitrogen gas simultaneous as the generation of the free radicals.

FIG. 3 depicts the radical generation of a persulfate species, potassium persulfate, which does not produce gascous side products.

FIG. 4 shows the comparison of Fourier Transform Infrared Spectroscopy (FTIR) results between the reactants for TPP synthesis, tetrabutylphosphonium chloride (TPCI), ammonium persulfate (AP) and the product TPP.

FIG. 5 shows the comparison of FTIR results between the reactants for C8MP synthesis, 1-octyl-3-methylimidazolium (C8MC), ammonium persulfate (AP) and the product C8MP.

FIG. 6 shows a photograph of 1% TPP fully dissolved in conventional carbonate electrolyte (left), and ammonium persulfate (AP) which is unable to dissolve in the same electrolyte at 1% (right).

FIG. 7 shows a photograph of a gas-free in-situ cured glyme electrolyte-based QSE in a sample bottle.

FIG. 8 shows a photograph of a gas-free in-situ cured carbonate electrolyte-based QSE in a sample bottle.

FIG. 9 shows two consecutive charge-discharge cycles of a gas-free in-situ cure quasi solid state pouch battery of approximately 30 mAh capacity, which is based on lithium metal as the anode, and which employs a glyme electrolyte-based QSE.

FIG. 10 shows two consecutive charge-discharge cycles of a gas-free in-situ cure quasi solid state pouch battery of approximately 30 mAh capacity, which is based on graphite as the anode, and which employs a carbonate electrolyte-based QSE.

FIG. 11 compares differential scanning calorimetry results for TPP under different heating rates.

FIG. 12 shows the Kissinger plot of 1n(β/Tₚ²) vs 1/Tₚ. The fitting of the plot is also shown, which shows the slope and Y-axis intersect.

FIG. 13 shows the comparison of rate performance tests between a gas-free in-situ cured quasi solid state lithium ion battery pouch from TPP curing of 6% monomers (6% QSE-TPP) and a gas-generating in-situ cured quasi solid state lithium ion battery pouch from AIBN curing of the same 6% monomers (6% QSE-AIBN). The pouch batteries consist of lithium cobalt oxide cathode, a graphite anode and a polyolefin-based separator.

FIG. 14 shows the comparison of cycling performance test results between a gas-free in-situ cured quasi solid state lithium ion battery pouch from TPP curing of 6% monomers (6% QSE-TPP) and a gas-generating in-situ cured quasi solid state lithium ion battery pouch from AIBN curing of the same 6% monomers (6% QSE-AIBN). The pouch batteries consist of lithium cobalt oxide cathode, a graphite anode and a polyolefin-based separator.

FIG. 15 shows the comparison of discharge rate performance tests between liquid electrolyte batteries and QSE batteries. The pouch batteries consist of lithium cobalt oxide cathode, a graphite anode and a polyolefin-based separator. The QSE for these batteries consists of 6% polymer (monomers), 94% liquid electrolyte and TPP was used as the thermal initiator. For the QSE batteries, accelerated wetting was carried out by acoustic vibration with an acceleration rate of 20 gravitational units (20 G) for 6 hours before thermal curing. The discharge rate test was carried out using a charging rate of 0.2 C and discharged at different C-rates as indicated on the graph.

FIG. 16 shows the comparison of discharge rate performance tests between liquid electrolyte batteries and QSE batteries. The pouch batteries consist of lithium cobalt oxide cathode, a graphite anode and a polyolefin-based separator. The QSE for these batteries consists of 10% polymer (monomers), 90% liquid electrolyte and TPP was used as the thermal initiator. For the QSE batteries, accelerated wetting was carried out by acoustic vibration with an acceleration rate of 20 gravitational units (20 G) for 6 hours before thermal curing. The discharge rate test was carried out using a charging rate of 0.2 C and discharged at different C-rates as indicated on the graph.

FIG. 17 shows the cycle performance test of QSE batteries benchmarking the performance of batteries using the same liquid electrolyte. The QSE precursor contained 6% of monomers, 94% of a carbonate based liquid electrolyte and TPP was used as the thermal initiator. The pouch batteries were comprised of lithium cobalt oxide as the cathode, graphite anode, and a polyolefin-based separator. The QSE batteries, after the injection of the QSE precursor, had been subjected to an accelerated wetting procedure by acoustic vibration with an acceleration rate of 20 gravitational units (20 G) for 6 hours. Afterwards, only thermal curing was carried out. The battery cycle test was carried out using 0.5 C charging rate and 1C discharging rate.

FIG. 18 shows the comparison of discharge rate performance tests between liquid electrolyte batteries and QSE batteries. The pouch batteries consist of a nickel-rich lithium nickel manganese cobalt oxide (NMC811) cathode, a graphite anode and a polyolefin-based separator. The electrodes used in this example are high energy density electrodes, with an areal capacity of 3.3 mAh/cm2. The QSE for these batteries consists of 7% polymer (monomers), 93% liquid electrolyte and TPP was used as the thermal initiator. For the QSE batteries, accelerated wetting was carried out by acoustic vibration with an acceleration rate of 20 gravitational units (20 G) for 6 hours before thermal curing. The discharge rate test was carried out using a charging rate of 0.2 C and discharged at different C-rates as indicated on the graph.

FIG. 19 shows the cycle performance test of QSE batteries benchmarking the performance of batteries using the same liquid electrolyte. The QSE precursor contained 7% of monomers, 93% of a carbonate based liquid electrolyte and TPP was used as the thermal initiator. The pouch batteries were comprised of a nickel rich lithium nickel manganese cobalt oxide (NMC811) as the cathode, graphite anode, and a polyolefin-based separator. The electrodes used in this example are high energy density electrodes, with an areal capacity of 3.3 mAh/cm². The QSE batteries, after the injection of the QSE precursor, was subjected to an accelerated wetting procedure by acoustic vibration with an acceleration rate of 20 gravitational units (20 G) for 6 hours. Afterwards, only thermal curing was carried out. The battery cycle test was carried out using 0.5 C charging and discharging rate.

FIG. 20 shows the comparison of discharge rate performance tests between liquid electrolyte batteries and QSE batteries. The pouch batteries consist of a nickel-rich lithium nickel manganese cobalt oxide (NMC811) cathode, a lithium metal anode and a polyolefin-based separator. The QSE for these batteries consists of 8% polymer (monomers), 92% liquid electrolyte and TPP was used as the thermal initiator. The discharge rate test was carried out using a charging rate of 0.1 C and discharged at 0.1 C for the first 5 cycles, and subsequently charged at a rate of 0.2 C and discharged at different C-rates as indicated on the graph.

FIG. 21 shows the comparison of cycle test results between a liquid electrolyte battery and a QSE battery. The pouch batteries consist of a nickel-rich lithium nickel manganese cobalt oxide (NMC811) cathode, a lithium metal anode and a polyolefin-based separator. The QSE for these batteries consists of 8% polymer (monomers), 92% liquid electrolyte and TPP was used as the thermal initiator. The cycling test was carried out at a rate of 0.5 C charge and discharge.

FIG. 22 shows the hotbox testing result of a liquid electrolyte battery. The battery had a capacity of 1.4 Ah, and consisted of lithium cobalt oxide cathode, graphite anode and polyethylene (PE)-based separator. Heating was carried out from ambient temperature at a rate of about 5 Celsius degrees per minute. The battery suffered a thermal runaway when the oven temperature reached 120 Celsius degrees.

FIG. 23 shows the hotbox testing result of a QSE battery using 7% polymer (monomer). The battery had a capacity of 1.4 Ah, and consisted of lithium cobalt oxide cathode, graphite anode and polyethylene (PE)-based separator. Heating was carried out from ambient temperature at a rate of about 3-5 Celsius degrees per minute. The battery suffered a thermal runaway when the oven temperature reached 135 Celsius degrees.

FIG. 24 shows the hotbox testing result of a QSE battery using 10% polymer (monomer). The battery had a capacity of 1.4 Ah, and consisted of lithium cobalt oxide cathode, graphite anode and polyethylene (PE)-based separator. Heating was carried out from ambient temperature at a rate of about 3-5 Celsius degrees per minute. The battery did not suffer a thermal runaway when the oven temperature reached 150 Celsius degrees, and passed the hotbox test at 150 Celsius degrees for 1 hour.

FIG. 25 shows the hotbox results of a 1.3 Ah capacity QSE battery of lithium nickel manganese cobalt oxide (NMC811) as the cathode, graphite anode, and a polyolefin-based separator. The electrodes used in this example are high energy density electrodes, with an area capacity of 3.3 mAh/cm². The QSE had 7% polymer content and 93% liquid electrolyte components. This battery was able to withstand the heating up to a temperature of 150 Celsius degrees, and did not suffer a thermal runaway for 1 hour at 150 Celsius degrees, and throughout the hotbox test keeping a high voltage >4V.

### DETAILED DESCRIPTION

The application of QSE in batteries aims, in principle, to combine the safety advantages of solid state electrolytes and the performance characteristics of liquid electrolytes. However, in practice, QSE incorporated batteries suffer from consistency issues and which lead to severe performance decrease, due to gas bubbles that is generated during the in-situ curing of QSE. Thus, in the first aspect, a need for non-gas evolving in-situ curing of QSE arise, as non-gas evolving curing of QSE ensures uniform application of QSE throughout the battery, consequently effects a better performance for the battery.

The gas in the typical QSE is generated due to the polymerization initiators used in the QSE precursors for in-situ curing, such as azobisisobutyronitrile (AIBN) and similar nitrile based initiators that are typically used. These initiators, when heated above the initiating temperature, eliminate a molecule of nitrogen gas during decomposition to form free radicals, which subsequently initiate the polymerization reaction. When a sufficient amount of nitrogen gas molecules are present in the polymerization mixture, gas bubbles therefore nucleate and grow. In order to avoid gas-bubbles in the QSE, a non-gassing initiator is required. For this invention, a non-gassing initiator is developed for triggering the in-situ polymerization process of the QSE.

The present invention determined that the non-gassing initiator, however, must fulfill several other requirements in order to qualify for a QSE initiator, such as: 1) good solubility with the liquid electrolyte components used in lithium batteries, 2) a relatively low initiating temperature, and 3) facile polymerization kinetics with the targeted monomer. Examples of such non-gassing initiators are found in the persulfate anion-based ionic liquid family, for the curing of acrylate-based monomers. In an embodiment, a persulfate ionic liquid is used as a non-gassing initiator, and the resulting non-gas evolving in-situ cured quasi-solid-state batteries can operate normally, without the problems associated with gas voids in the prior art. The non-gas evolving in-situ curing technique is applicable to a wide range of liquid electrolytes, making it suitable for the whole range of lithium batteries, from graphite anode-based lithium ion batteries to lithium metal anode-based lithium metal batteries.

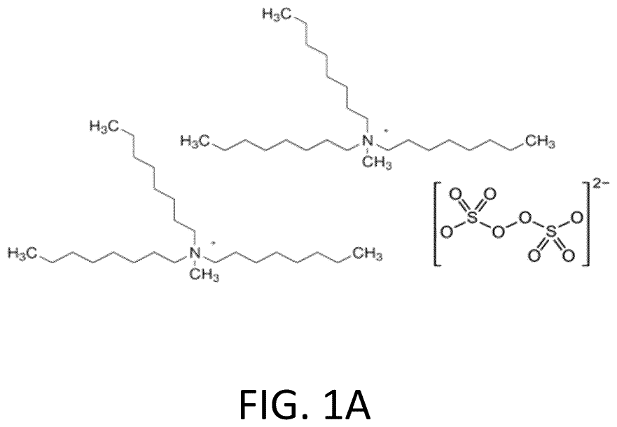

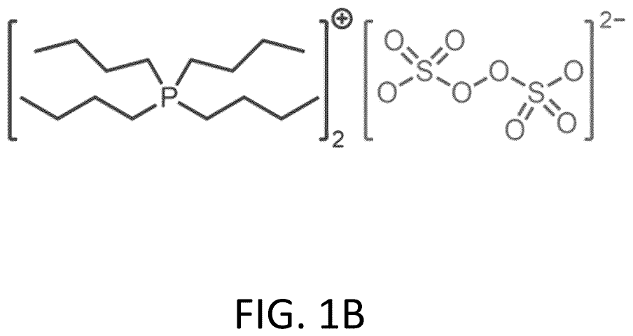

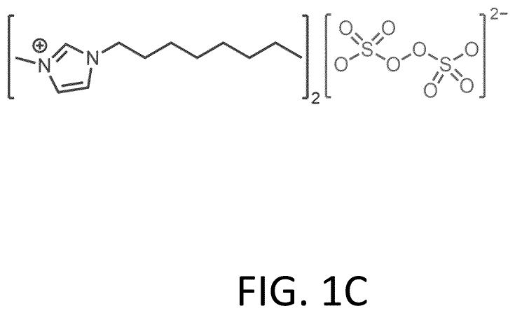

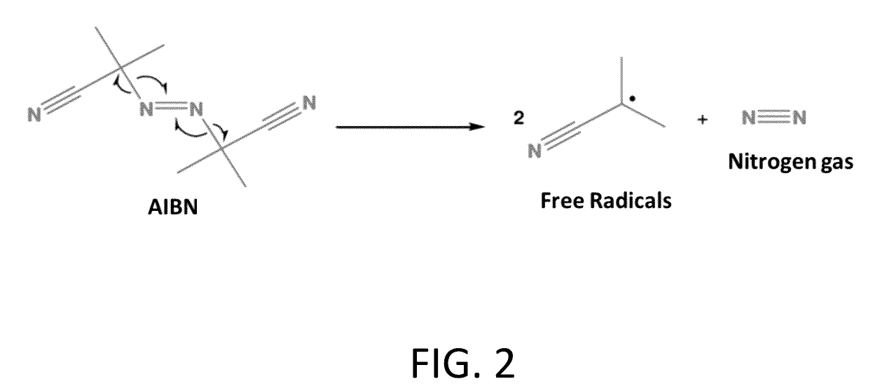

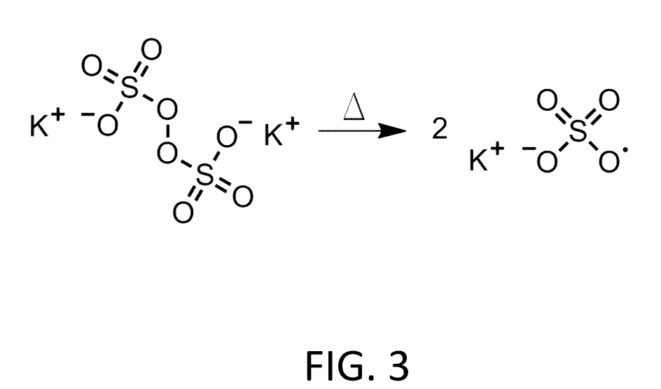

An example of a non-gas evolving polymerization initiator is shown in FIG. 1. As can be seen here, the quaternary ammonium persulfate species has bulky cations that aid solubility with QSE precursors, whereas the persulfate anion generates the free-radical for polymerization initiation without giving off gas molecules.

Other innovative aspects of the present invention address the need of the QSE to exhibit high ionic conductivity, which translates to higher power capacity for the battery. Further, the high oxidative stability of the QSE enables the resultant high energy density battery to be able to withstand high voltage environments.

To obtain higher ionic conductivity, the present invention determined that it is advantageous for the QSE to contain as high of a proportion of liquid electrolyte as possible. However, in order for the QSE to accommodate this high amount of liquid electrolyte, the polymer component of the QSE has to have exceptional swelling performance. For example, a high-power-capable QSE may be required to have less than 10% polymer content, and more than 90% liquid electrolyte content. Using a low percentage of the polymer, requires that the monomer has to readily swell with a high amount of liquid electrolyte prior to curing followed by rapid curing upon initiation.

As discussed above, the high-performance monomer has to be able to swell and hold the significantly larger amounts of liquid electrolyte in the QSE, and yet able to achieve a facile curing upon initiation. For high swelling performance, it is generally favorable for the monomers to have a considerable chain length between each cross-linking point; in other words, to have a considerable molecular weight of the polymer backbone per unit of the polymerization functional group. A typical monomer that possesses these characteristics has a molecular weight of the polymer backbone unit in the range between about 250-3000 per unit of polymerization functional group. For facile curing upon initiation, it is favorable for the monomer to have at least two or more polymerization functional groups. Typically, the monomers employed in QSE have two or three polymerization functional groups. Nevertheless, monomers with more functional groups can be introduced to accelerate the curing process, or monomers with just one polymerization functional group may be introduced for other performance tuning purposes.

For the QSE to have high oxidative stability to withstand the high applied voltage in batteries, the monomer/polymer must be intrinsically stable against oxidation. However, a larger contribution comes from the oxidative stability of the liquid QSE component, as the liquid component makes up the majority of the QSE content. To this effect, the stability of the liquid electrolyte is improved through the use of additives and/or through development of advanced formulation to achieve unique electrolyte solvation structure for oxidative stability enhancement.

For example, for the carbonate-based electrolyte that is typically used in graphite-based lithium ion batteries, stabilizing additives such as vinylene carbonate (VC), fluoroethylene carbonate (FEC), lithium difluoro(oxalato)borate (LiDFOB), lithium difluorophosphate (LiDFP), succinonitrile, and adiponitrile and similar additives may be used. However, for batteries based on lithium metal anodes (e.g., lithium metal batteries), which typically use glyme solvents for the electrolyte, (e.g., dimethoxyethane, diethyleneglycol dimethylether (or diglyme), triethyleneglycol dimethylether (or triglyme)) the unique solvation structure with enhanced oxidative resistance is achieved through high salt concentration formulations. The high concentration electrolytes typically use lithium bis(trifluoromethanesulfonyl)imide (LiTFSI) and lithium bis(fluorosulfonyl)imide (LiFSI) as the lithium salt, at concentrations around at least 2M or higher. It is worth noting that advanced, high-stability liquid electrolyte compositions have yet to be formulated with the monomer components to form a QSE precursor solution for injection to an assembled battery. A corollary is that the monomer and curing system developed has to be able to accommodate the whole range of liquid electrolytes to be commercially viable, and this aspect is also covered in this invention. Compatibility of the monomers with the wide range of liquid electrolyte can be tuned through the use of different components on the polymer backbone. Typical QSE polymers are based on ethylene oxide or ethylene glycol as the component of the backbone. To further increase compatibility with large numbers of electrolyte solvents, it is advantageous to include propylene oxide groups on the polymer backbone, in a random fashion. The random copolymer backbone design is highly versatile in that the ratios of ethylene oxide and propylene oxide groups can be further varied to accommodate the full range of liquid electrolytes, and for different application needs.

The universality of the non-gas evolving in-situ cured QSE of this invention is demonstrated from the non-gas evolving in-situ cured quasi solid state lithium ion batteries, containing carbonate based electrolyte as the liquid component of the QSE and also the non-gas evolving in-situ cured quasi solid state lithium metal batteries, using glyme based electrolyte as the liquid component of the QSE.

In other aspects, the polymer component of the QSE may also be produced from allyl-based monomer polymerization. In the case of allyl-based monomers, the non-gas evolving in-situ curing initiators same as those for acrylate-based monomers can be used.

Therefore, the non-gas evolving in-situ cured quasi solid state batteries invention is a versatile, practical approach that not only result in batteries with improved safety, the non-gas evolving in-situ cured QSE translate to more uniform application of QSE in batteries, better battery performance and also more applicable for large scale QSE battery manufacturing. The curing system of this QSE invention is also capable of accommodating a wide range of electrolytes for the whole spectrum of lithium batteries. The universality of the non-gas evolving in-situ curing technique opens the possibility for all kinds of high performance QSE based solid state batteries.

Particular examples of the present invention include lithium ion batteries using lithium compound cathodes (e.g., lithium cobalt oxide (LCO), lithium manganese oxide (LMO), lithium iron phosphate (LFP), lithium nickel manganese cobalt oxide (NMC and NMC532), nickel rich lithium nickel manganese cobalt oxide (NMC622 or NMC811), lithium nickel cobalt aluminum oxide (NCA), lithium cobalt phosphate (LiCoPO₄) lithium vanadium phosphate (LVP), or a combination thereof) and a variety of anodes, including copper current collectors coated with one or more of graphite, hard carbon, soft carbon, silicon-carbon composite, silicon oxide-carbon composite, sulfur-carbon composite, lithium titanium oxide. The ion conductive electrolytic solution for lithium ion batteries is typically a carbonate-based electrolytic solution having a carbonate solvent, one or more lithium salts and one or more additives. The carbonate solvent may be one or more of ethylene carbonate (EC), propylene carbonate (PC), dimethyl carbonate (DMC), diethyl carbonate (DEC), ethyl methyl carbonate (EMC), fluoroethylene carbonate (FEC), vinylene carbonate (VC), or a combination thereof. The one or more lithium salts are selected from one or more of lithium hexafluorophosphate (LiPF₆), lithium tetrafluoroborate (LiBF₄), lithium bisfluorosulfonylimide (LiFSI), lithium bis(trifluoromethanesulfonyl)imide (LiTFSI), lithium bis(oxalate) borate (LiBOB), lithium difluoro(oxalato) borate (LiDFOB), lithium difluorophosphate (LiDFP), lithium nitrate, or a combination thereof. The one or more additives are selected from one or more of tris(trimethylsilyl) phosphate (TMSP), tris(trimethylsilyl) borate (TMSB), tris(trimethylsilyl) phosphite (TMSPi), succinonitrile, adiponitrile, or a combination thereof. The salts are present in the solvent at concentrations of approximately 1-2 mol/dm³. The additives are present in the ion conducting electrolytic solutions in the amount of approximately 0.1-5%.

The monomers for the QSE may be acrylate-based monomers or allyl-based monomers (or mixtures of these monomers). When using these monomers, the non-gas evolving polymerization initiator is one or more of a quaternary ammonium persulfate compound, or a quaternary phosphonium persulfate compound, or an imidazolium persulfate compound, examples of which include tricaprylmethylammonium (Aliquat) persulfate, tetrabutylphosphonium persulfate, or trihexyltetradecylphosphonium persulfate, 1-octyl-3-methylimidazolium persulfate.

In another aspect, the QSE may additionally include cross-linkers of the thiol family, which will promote the thiol-ene click reactions.

In another aspect, the present invention is useful for lithium metal batteries that use lithium metal as an anode (for example, as lithium coated on a copper current collector). For lithium metal batteries, the electrolytic solution is typically a glyme-based electrolytic solution. The glyme-based electrolytic solution uses a glyme-based solvent and one or more lithium salts. Examples of glyme solvents are dimethoxyethane (DME), diethoxyethane (DEE), diethylene glycol dimethyl ether (Diglyme, or G2), triethylene glycol dimethyl ether (triglyme, or G3), tetraethylene glycol dimethyl ether (tetraglyme, or G4), diethylene glycol diethyl ether (DEGDEE, or ethyl diglyme) or combinations of these solvents. The lithium salts used in with these solvents include lithium bisfluorosulfonylimide (LiFSI), lithium bis(trifluoromethanesulfonyl)imide (LiTFSI), lithium bis(oxalate) borate (LiBOB), lithium difluoro(oxalato) borate (LiDFOB), lithium difluorophosphate (LiDFP), lithium nitrate, or combinations of these salts. The salts are used at concentrations of 1.5 mol/dm³ or above. Advantageously, the same monomers that are used with lithium ion batteries may also be used with the solvent systems of lithium metal batteries, that is, acrylate-based monomers or allyl-based monomers, with the corresponding polymerization initiators discussed above.

In making batteries using the QSEs of the present invention one or more lithium salts are mixed with a solvent. A quasi-solid electrolyte precursor solution is prepared by mixing at least one monomer, the high ion conductivity electrolytic solution, and a non-gas evolving polymerization initiator.

The quasi-solid electrolyte precursor solution is injected into a pre-packaged lithium battery. The battery filled with the quasi-solid electrolyte precursor is subjected to a conditioning step for electrode wetting. This is followed by in-situ curing for curing the quasi-solid electrolyte by heating at a temperature in the range of 50-80° C. for a duration less than 12 hours.

### EXAMPLES

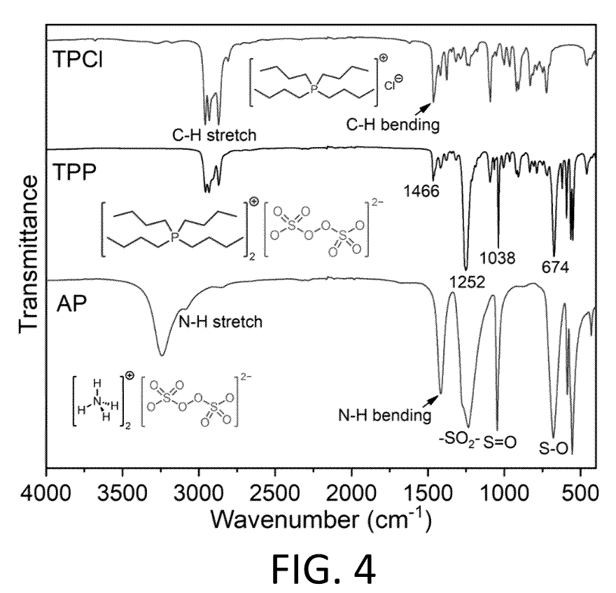

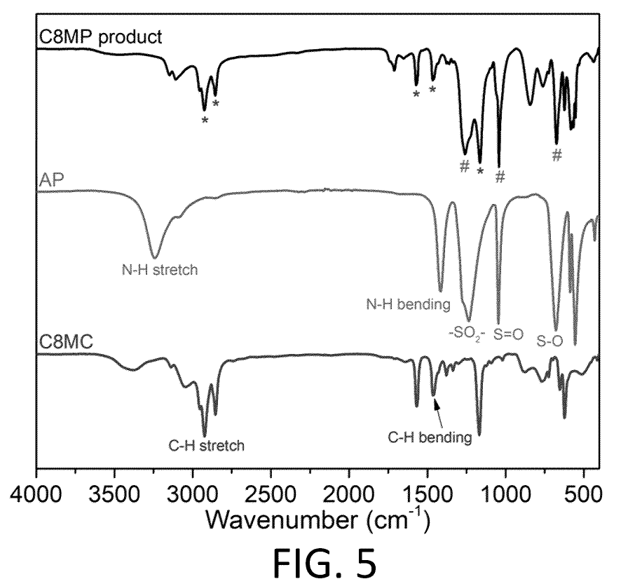

FIG. 4 shows the Fourier Transform Infrared Spectroscopy (FTIR) comparison between the reactants for TPP synthesis, tetrabutylphosphonium chloride (TPCI), ammonium persulfate (AP) and the product TPP. The peak assignments for the FTIR are as follows: C—H stretching at 3000-2800 cm⁻¹, C—H bending at 1466 cm⁻¹, R—SO2-R stretching at 1252 cm⁻¹, S═O stretching at 1038 cm⁻¹, and S═O stretching at 674 cm⁻¹. The FTIR results show that clean TPP specimen has been synthesized, producing the characteristic peaks for the tetrabutylphosphonium cation as in C—H stretching and bending, and also the characteristic peaks for persulfate anion as S═O and S—O stretching. Similarly, FIG. 5 shows the FTIR comparison between the reactants for C8MP synthesis, and the product C8MP, confirming the C8MP product.

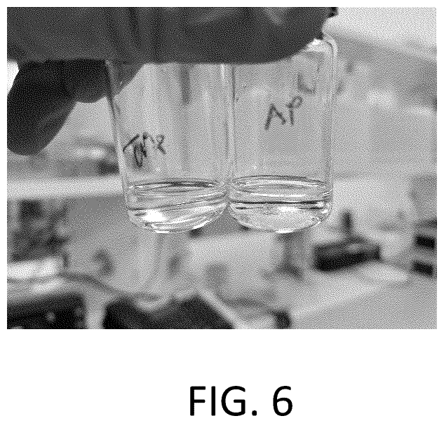

A simple solubility demonstration is shown in FIG. 6, where 1% of tetrabutylphosphonium persulfate (TPP) or ammonium persulfate (AP) was mixed with the conventional carbonate electrolyte. As can be seen, ammonium persulfate was completely insoluble in the electrolyte, and the powder remained at the bottom of the glass vial after a long period of mixing. Whereas TPP dissolved into the liquid electrolyte instantly. This shows the efficacy of the cation substitution in tuning the solubility of the persulfates into liquid electrolytes.

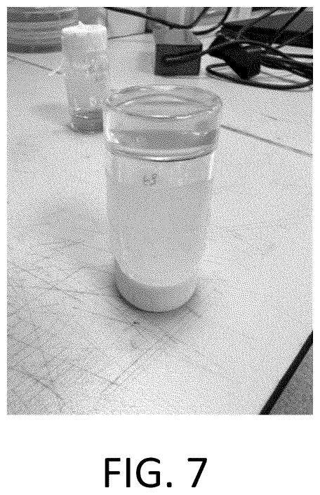

FIG. 7 shows a cured QSE in sample bottle. This QSE is comprised of 10% of acrylate polymers and 90% of a glyme-based electrolyte. The glyme-based version of QSE is intended for using in batteries employing lithium metal as the battery anode. The sample bottle was tilted upside-down to show the complete gelation of the gas-free in-situ cured QSE.

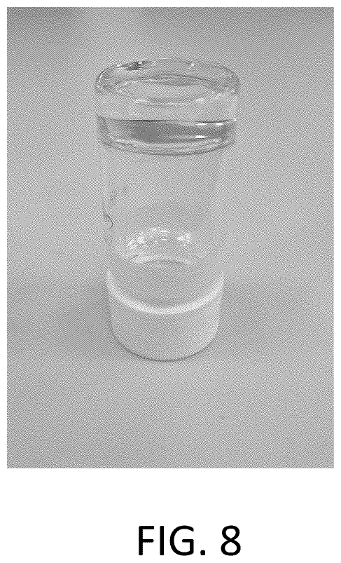

FIG. 8 shows a different version of QSE in sample bottle, which is based on the carbonate liquid electrolyte. This QSE is comprised of 10% of acrylate polymers and 90% of the carbonate-based liquid electrolyte. The carbonate-based version of QSE is intended for lithium ion batteries using graphite or graphite composite or carbon composite as the battery anode.

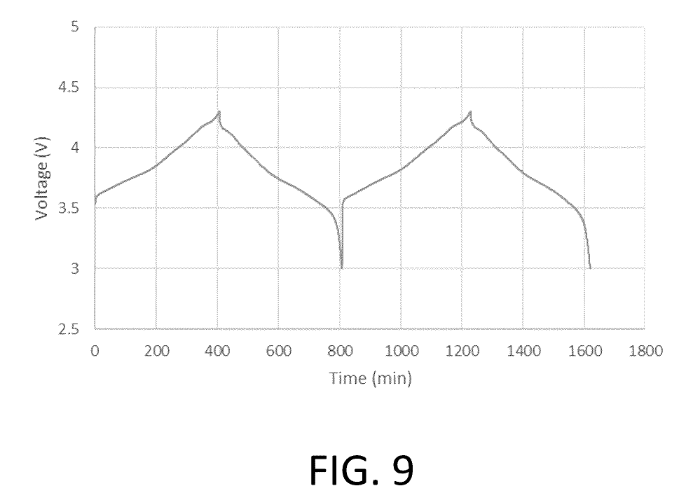

FIG. 9 shows two consecutive charge discharge cycles of a gas-free in-situ cured quasi solid state pouch battery of approximately 30 mAh capacity. For this battery, the cathode was based on NCM811 and the anode was based on lithium metal. Correspondingly, the QSE was one of glyme-electrolyte based. The charge discharge current employed was approximately 0.15 C (full charge or discharge in approximately 7 hours). Two consecutive cycles are included in this plot to show that the QSE provides stable and repeatable performance in a real battery.

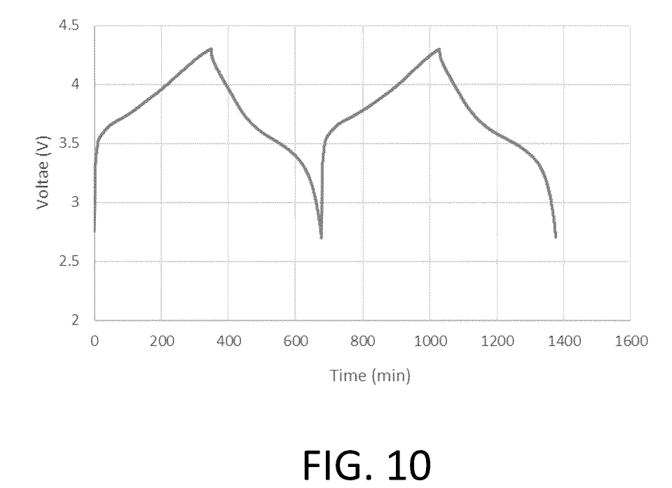

FIG. 10 shows two consecutive charge discharge cycles of a gas-free in-situ cured quasi solid state pouch battery of approximately 24 mAh capacity. For this battery, the cathode was based on NCM622 and the anode was based on graphite materials. Correspondingly, the QSE was one of carbonate-electrolyte based. The charge discharge current employed was approximately 0.17 C (full charge or discharge in approximately 6 hours). Two consecutive cycles are included in this plot to show that the QSE provides stable and repeatable performance in a real battery.

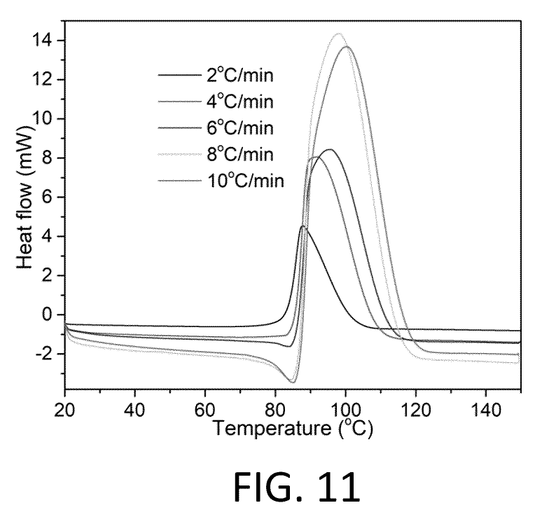

The decomposition kinetics of the thermal initiators across a temperature range are crucially important information that guides the application in QSE-curing or any polymerization initiation. For example, the kinetics information covers the shelf-life of the initiator under storage condition and also inform the temperature above which polymerization initiation will occur. The decomposition kinetics for TPP has been determined using the Kissinger method from differential scanning calorimetry data under different heating rate, as shown in FIG. 11. The key information from the DSC curves relevant to the Kissinger method are summarized in Table 1 below.

TABLE 1
Parameters for Kissinger method determination of initiator
decomposition kinetics.

| Entry | Heating rate, ß | Peak temperature, Tₚ | $ln ( \frac{β}{{T}_{p}^{2}} )$ | $\frac{1000}{{T}_{p}}$ |
|---|---|---|---|---|
| 1 | 2 K/min | 360.890 | −11.084 | 2.771 |
| 2 | 4 K/min | 364.899 | −10.413 | 2.740 |
| 3 | 6 K/min | 368.695 | −10.028 | 2.712 |
| 4 | 8 K/min | 371.102 | −9.754 | 2.695 |
| 5 | 10 K/min | 373.256 | −9.542 | 2.679 |

The Kissinger method is based on the following equation:

$$ln ( \frac{β}{{T}_{p}^{2}} ) = - \frac{{E}_{a}}{{RT}_{p}} + ln ( \frac{AR}{{E}_{a}} )$$

where β is the heating rate, Tₚ is the peak temperature from the DSC curves, Ea is the activation energy, R is the gas constant, and A is the preexponential factor. From a graph of 1n(β/Tₚ²) vs 1/Tₚ, the slope would be −Eₐ/R, and the intercept on y-axis is 1n(AR/Eₐ).

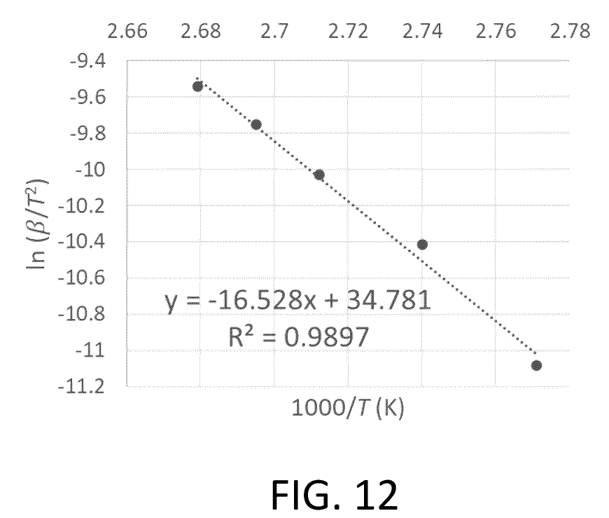

FIG. 12 shows the plot of 1n(B/Tₚ²) vs 1/Tₚ, from which the then Eₐ can be determined to be 137.414 KJ/mol, and the preexponential factor A is 2.106×10¹⁶ s⁻¹. The first order rate constant is then determined using the standard equation:

$$k = {Ae}^{\frac{- {E}_{a}}{RT}}$$

where k is the first order rate constant (s⁻¹), A is the preexponential factor, Eₐ is the activation energy (J mol⁻¹), R is the gas constant (8.314 J mol⁻¹ K⁻¹), and T is temperature (K).

From this calculation, it is obtained that the rate constant for TPP at temperature of 25 Celsius degree is 1.722×10⁻⁸ s⁻¹, corresponding to a half-life of 465 days, and at 45 Celsius degrees, the rate constant is 5.637×10⁻⁷ s⁻¹, corresponding to a half-life of 14.2 days. Calculations for other temperature is also possible based on the first order rate constant equation, but basically the half-life data means that the storage for TPP is suitable at temperature of 25 Celsius degrees or lower, and thermal initiation will require a temperature above 45 Celsius degrees.

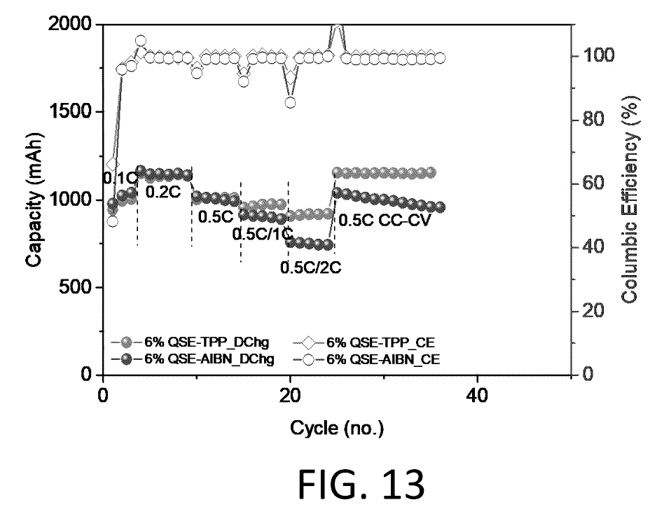

FIG. 13 shows the rate performance test results based on lithium cobalt oxide-graphite lithium ion battery pouch batteries containing quasi solid electrolytes, cured using non gas generating TPP (6% QSE-TPP) and gas generating AIBN (6% QSE-AIBN). The batteries delivered same capacity at the early cycles at low rates (0.1 C, 0.2 C, and 0.5 C charge and discharge, 0.1 C refers to charging rate for 10% capacity per hour, and 0.2 C likewise for 20% capacity per hour), but from the point when the battery was required to charge at 0.5 C and discharged at 1 C (0.5 C/1 C), and further to charge at 0.5 C and discharge at 2 C, it is clear that the 6% QSE-TPP battery delivered a significantly greater amount of capacity as compared to the 6% QSE-AIBN battery, showing that the TPP-cured battery, owing to a more uniform QSE curing, provide a much better battery performance.

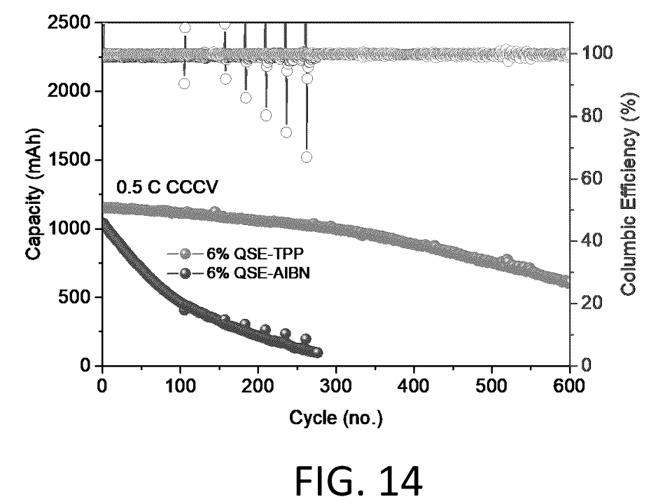

FIG. 14 shows the cycling performance test results using a 0.5 C rate, based on lithium cobalt oxide-graphite lithium ion battery pouch batteries containing quasi solid electrolytes, cured using non gas generating TPP (6% QSE-TPP) and gas generating AIBN (6% QSE-AIBN). The batteries have undergone the rate performance test as described in FIG. 13 before beginning the cycling test. As can be seen, the cycle performance of the TPP-cured QSE was far superior compared to the AIBN-cured QSE.

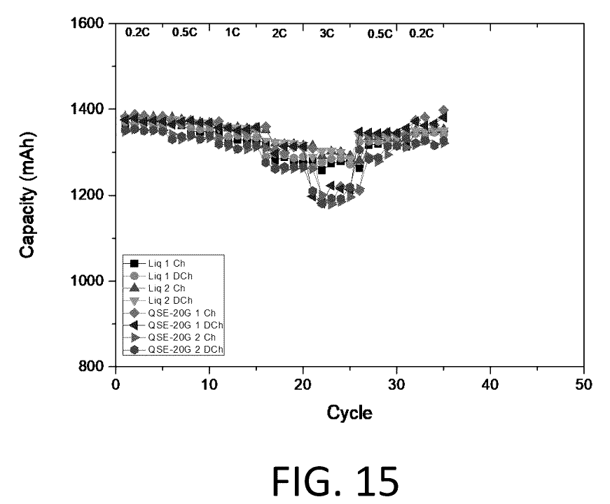

FIG. 15 shows the discharge rate performance test of QSE batteries benchmarking the performance of batteries using the same liquid electrolyte. The QSE precursor contained 6% of monomers, 94% of a carbonate based liquid electrolyte and TPP was used as the thermal initiator. The pouch batteries were comprised of lithium cobalt oxide as the cathode, graphite anode, and a polyolefin-based separator. The QSE batteries, after the injection of the QSE precursor, had been subjected to an accelerated wetting procedure by acoustic vibration with an acceleration rate of 20 gravitational units (20 G) for 6 hours. Afterwards, only thermal curing was carried out. The discharge rate test was carried out using a charging rate of 0.2 C and discharged at the different C-rates as indicated on the graph. From this graph, it can be seen that the QSE batteries were able to deliver the full capacity as the liquid electrolyte batteries up to 2 C discharge current, where the plots of capacity against the number of cycles fully overlap. It was only at 3 C discharge when the QSE batteries discharged slightly less capacity as compared to the liquid electrolyte battery, but even then, the capacity retention was still at 92%, which is a good performance.

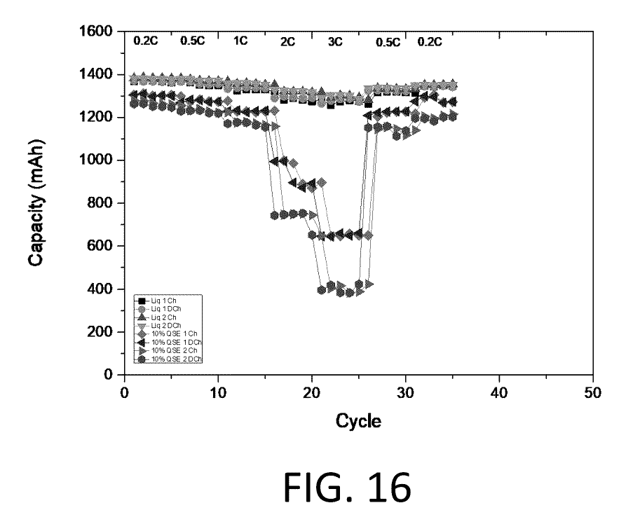

FIG. 16 shows the discharge rate performance test of QSE batteries benchmarking the performance of batteries using the same liquid electrolyte. The pouch batteries were comprised of lithium cobalt oxide as the cathode, graphite anode, and a polyolefin-based separator. In this case, the QSE precursor contained 10% of monomers, 90% of a carbonate based liquid electrolyte and TPP was used as the thermal initiator. The QSE batteries, after the injection of the QSE precursor, also had been subjected to an accelerated wetting procedure by acoustic vibration with an acceleration rate of 20 gravitational units (20 G) for 6 hours. Afterwards, only thermal curing was carried out. The discharge rate test was carried out using a charging rate of 0.2 C and discharged at the different C-rates as indicated on the graph. From this curve it can be seen that even at 10% monomer use, the QSE battery maintains a good capacity retention at a practical discharge rate of 1C, delivering approximately 90% capacity as compared to the liquid electrolyte battery. From 2 C onwards the capacity retention decreased slightly more and when 3 C discharge current was applied, only less than half of the full capacity was delivered. These results show that this battery may not be suitable for applications requiring a current above 2 C. But as this QSE battery uses 10% monomer/polymer, the greater proportion of polymer will further improve safety performance of the battery, while maintaining an appreciable rate performance at 1 C.

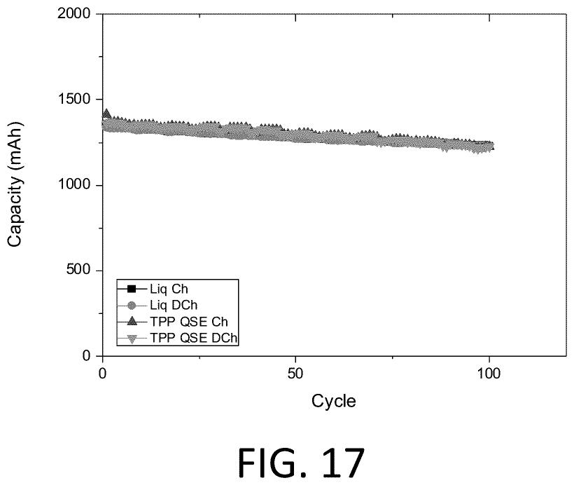

FIG. 17 shows the cycle performance test of QSE batteries benchmarking the performance of batteries using the same liquid electrolyte. The QSE precursor contained 6% of monomers, 94% of a carbonate based liquid electrolyte and TPP was used as the thermal initiator. The pouch batteries were comprised of lithium cobalt oxide as the cathode, graphite anode, and a polyolefin-based separator. The QSE batteries, after the injection of the QSE precursor, had been subjected to an accelerated wetting procedure by acoustic vibration with an acceleration rate of 20 gravitational units (20 G) for 6 hours. Afterwards, only thermal curing was carried out. The battery cycle test was carried out using 0.5 C charging rate and 1 C discharging rate. From this graph, it can be seen that the QSE battery were able to deliver the full capacity as the liquid electrolyte battery at this charging and discharging rate, and the cycle performance basically overlaps with the liquid electrolyte battery for the test duration of 100 cycles.

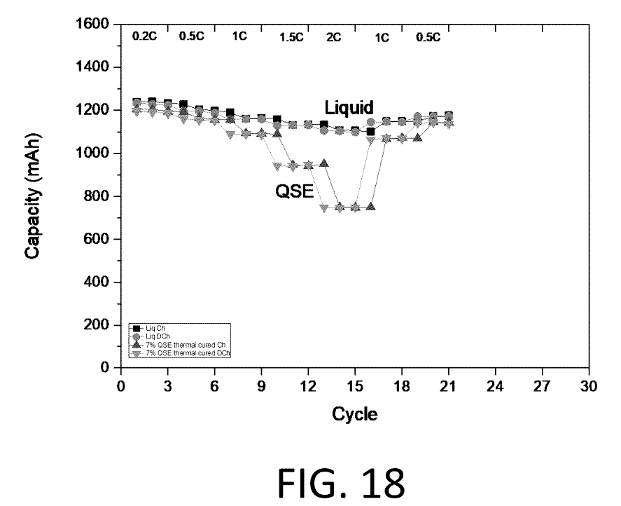

FIG. 18 shows the discharge rate performance test of QSE batteries benchmarking the performance of batteries using the same liquid electrolyte. The pouch batteries were comprised of a nickel rich lithium nickel manganese cobalt oxide (NMC811) as the cathode, graphite anode, and a polyolefin-based separator. The electrodes used in this example are high energy density electrodes, with an areal capacity of 3.3 mAh/cm². With this high areal capacity, the battery performance becomes ever more dependent on the ability of the QSE precursor to fully wet the electrodes and also that uniform curing can be carried out. The QSE precursor contained 7% of monomers, 93% of a carbonate based liquid electrolyte and TPP was used as the thermal initiator. The QSE batteries, after the injection of the QSE precursor, was subjected to an accelerated wetting procedure by acoustic vibration with an acceleration rate of 20 gravitational units (20 G) for 6 hours. Afterwards, only thermal curing was carried out. The discharge rate test was carried out using a charging rate of 0.2 C and discharged at the different C-rates as indicated on the graph. The QSE battery in this case achieved 94% capacity as compared to the liquid electrolyte battery at 1C, and maintained 67% capacity as compared to liquid electrolyte battery at 2 C. Considering the high areal capacity for this battery, the good rate performance of the QSE battery is ascribed to the uniform curing if QSE by the gas-free initiator.

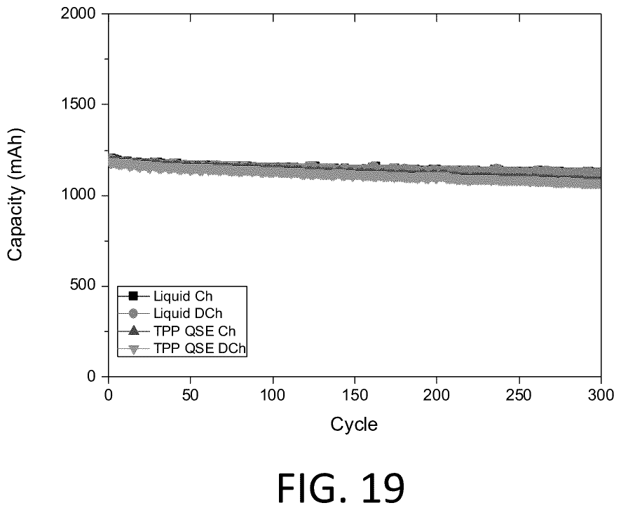

FIG. 19 shows the cycle performance test of QSE batteries benchmarking the performance of batteries using the same liquid electrolyte. The QSE precursor contained 7% of monomers, 93% of a carbonate based liquid electrolyte and TPP was used as the thermal initiator. The pouch batteries were comprised of a nickel rich lithium nickel manganese cobalt oxide (NMC811) as the cathode, graphite anode, and a polyolefin-based separator. The electrodes used in this example are high energy density electrodes, with an areal capacity of 3.3 mAh/cm². The QSE batteries, after the injection of the QSE precursor, was subjected to an accelerated wetting procedure by acoustic vibration with an acceleration rate of 20 gravitational units (20 G) for 6 hours. Afterwards, only thermal curing was carried out. The battery cycle test was carried out using 0.5 C charging and discharging rate. From this graph, it can be seen that the QSE battery were able to deliver the full capacity as the liquid electrolyte battery at this charging and discharging rate, and over a 250 cycle test, the QSE battery still maintain 96% capacity compared to the liquid electrolyte battery. This performance is ascribed to the uniform curing of the QSE offered by the non-gas generating thermal initiator TPP.

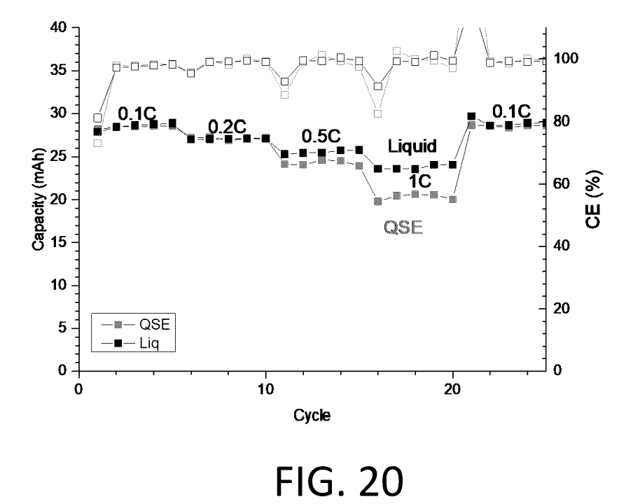

FIG. 20 shows the discharge rate performance test of QSE batteries benchmarking the performance of batteries using the same liquid electrolyte. The pouch batteries used for comparison were comprised of a nickel rich lithium nickel manganese cobalt oxide (NMC811) as the cathode and lithium metal as the anode, and a polyolefin-based separator and thus the battery is a lithium metal battery. The QSE precursor contained 8% of monomers, 92% of a glyme-based liquid electrolyte and TPP was used as the thermal initiator. The discharge rate test was carried out using a charging rate of 0.1 C and discharged at 0.1 C for the first 5 cycles, and subsequently charged at 0.2 C and discharged at the different C-rates as indicated on the graph. The QSE battery in this case achieved 85% capacity as compared to the liquid electrolyte battery at 1C.

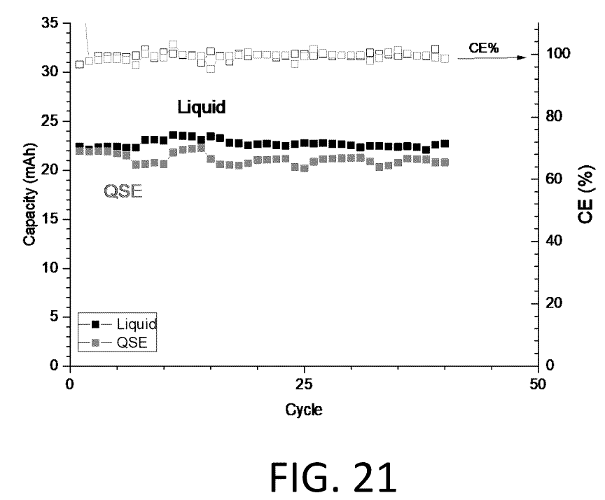

FIG. 21 shows the cycle performance test of a QSE battery comparing against the same battery using the same liquid electrolyte. The pouch batteries used for comparison were comprised of a nickel rich lithium nickel manganese cobalt oxide (NMC811) as the cathode and lithium metal as the anode, and a polyolefin-based separator and thus the battery is a lithium metal battery. The QSE precursor contained 8% of monomers, 92% of a glyme-based liquid electrolyte and TPP was used as the thermal initiator. The battery cycling test was carried out at a rate of 0.5 C charge and discharge. From this graph it can be seen that the capacity trend is mostly similar between the QSE battery and the liquid electrolyte battery.

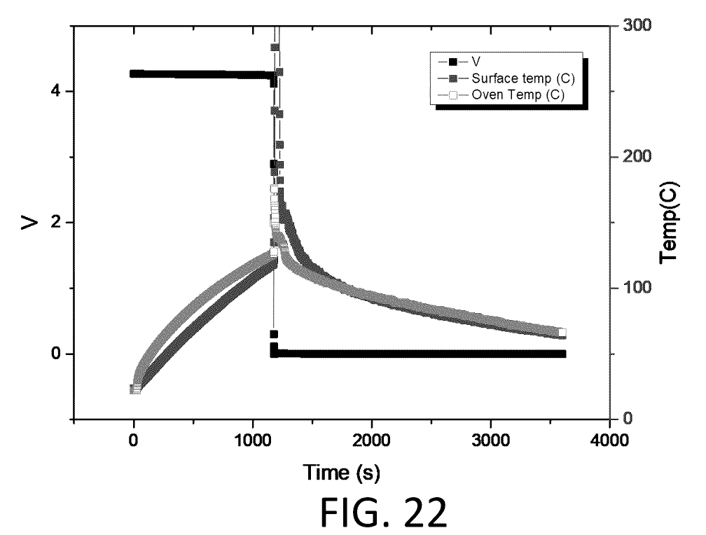

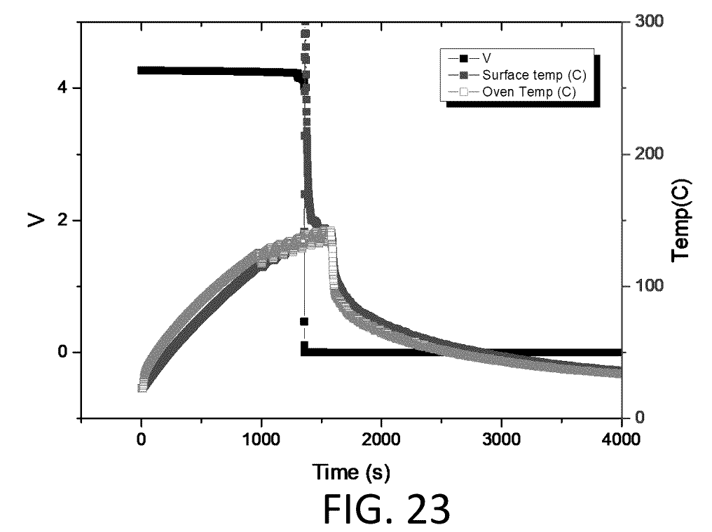

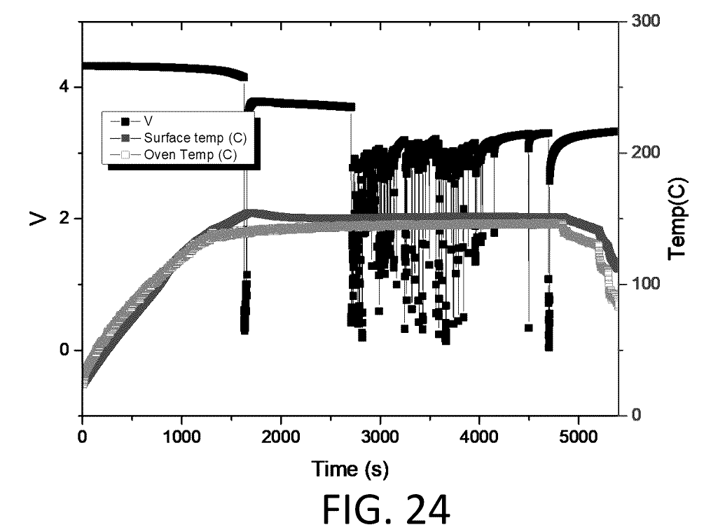

To show that QSE improves the safety performance of batteries, hotbox tests had been carried out to compare the safety improvement offered by QSE over liquid electrolyte. FIG. 22 shows the hotbox results of a liquid electrolyte, 1.4 Ah capacity battery comprising of lithium cobalt oxide cathode, graphite anode and a polyethylene separator. When subjected to heating at a rate of about 5 Celsius degree per minute, the battery suffered a thermal runaway when the oven temperature reached 120 Celsius, which began with a short circuit, showing up as the battery voltage dropped to 0V, and rapidly exploded, which is recorded as an abrupt temperature rise. Thus, as a baseline case, the liquid electrolyte battery fails the hotbox test at 120 Celsius degrees. When a 6% polymer QSE was applied to the battery for the same hotbox test, the thermal runway temperature increased from 120 Celsius degrees to 135 Celsius degrees, the results are as shown in FIG. 23, which demonstrate an improved thermal performance for batteries using QSE. When the polymer content of the QSE was further increased to 10%, the battery was then able to withstand the heating up to a temperature of 150 Celsius degrees, and did not suffer a thermal runaway for 1 hour at 150 Celsius degrees, as shown in FIG. 24. Passing a hotbox test at 150 Celsius degrees is a significant result for batteries utilizing polyethylene separators. It is anticipated that combinations of QSE with higher thermal resistant separators will further improve the hotbox temperature.

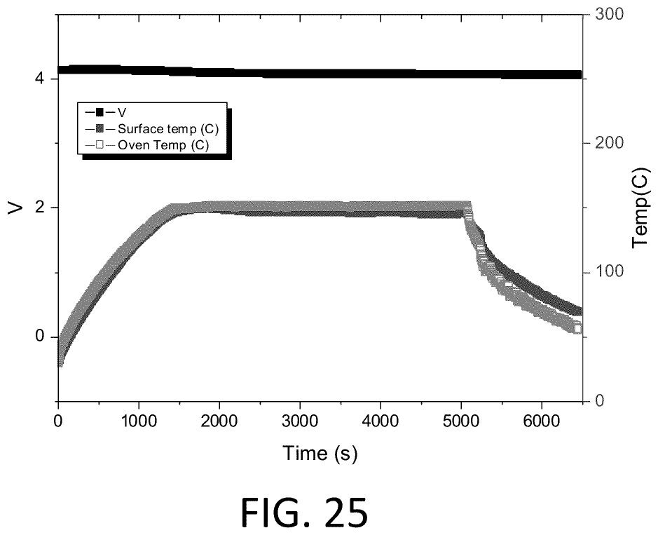

FIG. 25 shows the hotbox results of a 1.3 Ah capacity QSE battery of lithium nickel manganese cobalt oxide (NMC811) as the cathode, graphite anode, and a polyolefin-based separator. The electrodes used in this example are high energy density electrodes, with an area capacity of 3.3 mAh/cm². The QSE had 7% polymer content and 93% liquid electrolyte components. Under the temperature of 150 Celsius degrees and a high voltage of >4V, this battery was able to withstand the harsh conditions and did not suffer a thermal runaway for 1 hour throughout the hotbox test, showcasing its significant thermal resistance and ability to maintain performance under high voltage environments.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of +10%, +5%, +1%, or +0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within +10%, +5%, +1%, or +0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A method for fabricating a non-gas evolving in-situ cured quasi solid-state battery, comprising:
synthesizing at least one high ion conductivity electrolytic solution by mixing one or more lithium salts with a solvent and one or more additives;
preparing a non-gas evolving in-situ cured quasi-solid electrolyte precursor solution by mixing at least one monomer, the high ion conductivity electrolytic solution, and a non-gas evolving polymerization initiator;
injecting the non-gas evolving in-situ cured quasi-solid electrolyte precursor solution into a pre-packaged lithium battery;
subjecting the battery filled with the non-gas evolving in-situ cured quasi-solid electrolyte precursor solution to a conditioning step for wetting; and
in-situ curing for curing the non-gas evolving in-situ cured quasi-solid electrolyte by heating the non-gas evolving in-situ cured quasi-solid electrolyte precursor solution at a temperature in the range of approximately 50-80° C. for a duration of approximately 12 hours or less.

2. The method for fabricating the non-gas evolving in-situ cured quasi solid-state battery of claim 1, wherein the non-gas evolving in-situ curable quasi solid electrolyte precursor solution comprises a monomer in the range of 3-50% by weight, and an ion conductive electrolytic solution in the range of 50-97% by weight.

3. The method for fabricating the non-gas evolving in-situ cured quasi solid-state battery of claim 2, wherein the ion conductive electrolytic solution is selected from one or more of carbonate based electrolytic solution or a glyme based electrolytic solution.

4. The method for fabricating the non-gas evolving in-situ cured quasi solid-state battery of claim 2, wherein the quasi-solid electrolyte precursor solution contains a non-gas evolving polymerization initiator.

5. The method for fabricating the non-gas evolving in-situ cured quasi solid-state battery of claim 4, wherein the non-gas evolving polymerization initiator is selected from a quaternary ammonium persulfate compound, a quaternary phosphonium persulfate compound or an imidazolium persulfate compound.

6. The method for fabricating the non-gas evolving in-situ cured quasi solid-state battery of claim 2, wherein the monomer is selected from one or more of an acrylate-based monomer or an allyl-based monomer.

7. The method for fabricating the non-gas evolving in-situ cured quasi solid-state battery of claim 2, wherein the monomer has a molecular weight in a range between 250-3000 per unit of a polymerization functional group of a backbone of an in-situ cured polymer.

8. The method for fabricating the non-gas evolving in-situ cured quasi solid-state battery of claim 2, wherein the monomer has one or more polymerization functional groups on each monomer, and wherein number of polymerization functional groups on each monomer ranges from 1 to 6.

9. The method for fabricating the non-gas evolving in-situ cured quasi solid-state battery of claim 3, wherein the ion conductive electrolytic solution is a carbonate-based electrolytic solution and wherein the carbonate-based electrolyte comprises a carbonate solvent, one or more lithium salts, and one of more additives;
wherein the carbonate solvent is selected from one or more of ethylene carbonate (EC), propylene carbonate (PC), dimethyl carbonate (DMC), diethyl carbonate (DEC), ethyl methyl carbonate (EMC), fluoroethylene carbonate (FEC), vinylene carbonate (VC), or a combination thereof; and
wherein the one or more lithium salts are selected from one or more of lithium hexafluorophosphate (LiPF₆), lithium tetrafluoroborate (LiBF₄), lithium bisfluorosulfonylimide (LiFSI), lithium bis(trifluoromethanesulfonyl)imide (LiTFSI), lithium bis(oxalate) borate (LiBOB), lithium difluoro(oxalato) borate (LiDFOB), lithium difluorophosphate (LiDFP), lithium nitrate, or a combination thereof; and
wherein the one of more additives are selected from one or more of tris(trimethylsilyl) phosphate (TMSP), tris(trimethylsilyl) borate (TMSB), tris(trimethylsilyl) phosphite (TMSPi), succinonitrile or adiponitrile.

10. The method for fabricating the non-gas evolving in-situ cured quasi solid-state battery of claim 3, wherein the ion conductive electrolytic solution is a glyme-based electrolytic solution, and wherein the glyme-based electrolytic solution comprises a glyme solvent and one or more lithium salts and wherein the glyme solvent is selected from one or more of dimethoxyethane (DME), diethoxyethane (DEE), diethylene glycol dimethyl ether (Diglyme, or G2), triethylene glycol dimethyl ether (Triglyme, or G3), tetraethylene glycol dimethyl ether (Tetraglyme, or G4), diethylene glycol diethyl ether (DEGDEE, or ethyl diglyme), or a combination thereof; and
wherein the one or more lithium salts are selected from one or more of lithium bisfluorosulfonylimide (LiFSI), lithium bis(trifluoromethanesulfonyl)imide (LiTFSI), lithium bis(oxalate) borate (LiBOB), lithium difluoro(oxalato) borate (LiDFOB), lithium difluorophosphate (LiDFP), lithium nitrate, or a combination thereof.

11. The method for fabricating the non-gas evolving in-situ cured quasi solid-state battery of claim 2, wherein the non-gas evolving polymerization initiator is selected from one or more of tricaprylmethylammonium persulfate, tetrabutylphosphonium persulfate, or trihexyltetradecylphosphonium persulfate, or 1-octyl-3-methylimidazolium persulfate.

12. A non-gas evolving in-situ cured quasi solid state battery, comprising:
an in-situ cured quasi solid electrolyte having a swellable polymer content of 3% to 10%, the polymer being formed using a non-gas evolving polymerization initiator, and a liquid amount of 90% to 97% such that the ionic conductivity and transport property approximates liquid electrolyte;
a separator, the separator having a first side and a second side;
a battery positive electrode positioned adjacent to the first side of the separator; and
a battery negative electrode positioned adjacent to the second side of the separator.

13. The non-gas evolving in-situ cured quasi solid-state battery of claim 12, wherein the battery positive electrode is a cathode.

14. The non-gas evolving in-situ cured quasi solid-state battery of claim 12, wherein the battery negative electrode is an anode.

15. The non-gas evolving in-situ cured quasi solid state battery of claim 12, wherein the battery positive electrode comprises an aluminium current collector coated with one or more of lithium cobalt oxide (LCO), lithium manganese oxide (LMO), lithium iron phosphate (LFP), lithium nickel manganese cobalt oxide (NMC and NMC532), nickel rich lithium nickel manganese cobalt oxide (NMC622 or NMC811), lithium nickel cobalt aluminium oxide (NCA), lithium cobalt phosphate (LiCoPO₄) lithium vanadium phosphate (LVP), or a combination thereof.

16. The non-gas evolving in-situ cured quasi solid-state battery of claim 12, wherein the battery negative electrode comprises a copper current collector coated with one or more lithium, graphite, hard carbon, soft carbon, silicon-carbon composite, silicon oxide-carbon composite, sulfur-carbon composite, lithium titanium oxide, or a combination thereof.

17. The non-gas evolving in-situ cured quasi solid-state battery of claim 12, wherein the separator is selected from one of more of polyethylene (PE) separator, polypropylene (PP) separator, polytetrafluoroethylene (PTFE) separator, polyimide (PI) separator, or a multilayer composite separator.

18. A quasi-solid electrolyte precursor solution, comprising:
one or more monomer precursors of a swellable polymer in an amount from 3 to 10 weight percent;
an ion conductive electrolytic solution in an amount from 90 to 97 weight percent; and
a non-gas evolving polymerization initiator.

19. The quasi-solid electrolyte precursor solution of claim 18, wherein the non-gas evolving polymerization initiator is selected from a quaternary ammonium persulfate compound, a quaternary phosphonium persulfate compound or an imidazolium persulfate compound.
